(19) United States
(12) Patent Application Publication
(10) Pub. No.: US 2024/0317428 A1
(43) Pub. Date: Sep. 26, 2024

(54) System and Method for Controlling a System with Mixed-State Matter

(71) Applicant: Mitsubishi Electric Research Laboratories, Inc., Cambridge, MA (US)

(72) Inventors: Saleh Nabi, Cambridge, MA (US); Avishai Weiss, Cambridge, MA (US)

(21) Appl. No.: 18/124,167

(22) Filed: Mar. 21, 2023

(51) Int. Cl. B64G 1/38; G05D 1/08

(52) U.S. Cl. CPC B64G 1/38; B64G 1/402

(57) ABSTRACT

The present disclosure discloses a system and a method for controlling a system with mixed-state matter including a solid-state matter with parts forming a container including a volume of fluid. The method includes collecting a feedback signal indicative of a state of the system and determining a control command to an actuator of the system at a current control step by solving an optimal control problem changing the state of the system according to a control objective subject to a heterogenous model of dynamics of the system, including a model of dynamics of the solid-state matter mutually coupled with a model of dynamics of the volume of fluid in the container. The method further includes submitting the control command to the actuator of the system to change the state of the system.

### TECHNICAL FIELD

The present disclosure relates generally to control systems, and more particularly to a system and a method for controlling a system with mixed-state matter.

### BACKGROUND

Sloshing of a liquid occurs in liquid propellant rockets, aircraft propellant tanks, ships, petroleum tankers, and other applications in which the fluids are contained. Sloshing of the liquid can cause a tank system to deviate due to buildup of kinetic energy of the liquid and its consequent interaction with walls of container.

For instance, in aerospace technology, the liquid sloshing is a well-recognized problem, particularly in liquid propellant launch spacecrafts, which tend to have an enormous percentage of their initial weight as fuel. When slosh waves are allowed to freely oscillate, the slosh waves tend to reach resonance. At the resonance, the slosh waves generally have maximum amplitude. Forces of sloshing fuel can cause the spacecraft to rotate about its spin axis. To mitigate such a problem, thrust vector correction methods are used to correct the nutation in the spacecraft. However, high magnitudes of the fuel sloshing forces can overpower the corrections being made and thus results in an increase in nutation and complete loss of control of the spacecraft. Therefore, interaction of the sloshing fuel and spacecraft motion directly impacts spacecraft performance and may lead to instability of the spacecraft.

Thus, a controller for controlling a system (such as a spacecraft) is desired to consider effects of the liquid sloshing to minimize effects of the liquid sloshing on the controlling of the system. Accordingly, there is a need for a controller that considers the liquid sloshing in controlling of the system.

### SUMMARY

It is an object of some embodiments to provide a controller for controlling a system with mixed-state matter including a solid-state matter with parts forming a container. The container includes a volume of fluid. Examples of the system with the mixed-state matter include a spacecraft having a container with fuel powering its motion, and a robot carrying a container with water or other types of fluid. It is also an object of some embodiments to a construct a heterogeneous model that models a mutual coupling between dynamics of the solid-state matter (e.g., container) and liquid-state matter (fluid). Additionally, it is an object of some embodiment to use the heterogeneous model in controlling of the system.

When the system is under operation, the container is subjected to external forces due to which sloshing of the fluid occurs. For example, during flight of the spacecraft, the sloshing of the fluid may occur due to motion of the container. Due to the sloshing of the fluid, a shape of the volume of the fluid changes. Further, some embodiments are based on the recognition that change in the shape of the volume of the fluid changes a location of a center of mass of the volume of fluid and thus a location of a center of mass of the system. Further, the change in the shape of the volume of the fluid changes velocity of the fluid. Some embodiments are based on the recognition that dynamics of the mixed-state matters are mutually coupled, i.e., the dynamics of the solid-state matter (e.g., container) and liquid-state matter (fluid) affect each other, and in theory, the mutual coupling between the dynamics of the solid-state matter and the liquid-state matter should be considered in designing a controller for controlling the system. However, such a mutual coupling is difficult to model.

Some embodiments are based on the realization that the mutual coupling between the dynamics of the solid-state matter and the liquid-state matter can be done by estimating the shape of the volume of the fluid caused by the motion of the container. Some embodiments are based on the further realization that the shape of the volume of the fluid changes the location of the center of mass of the volume of the fluid, and, hence, the mutual coupling can be done by including the center of mass of the volume of the fluid in a model of dynamics of the solid-state matter. Additionally, in some embodiments, the mutual coupling is done by including velocity of the fluid in the model of dynamics of the solid-state matter. In some alternate embodiments, the mutual coupling is done by including both the velocity of the fluid and the center of mass of the volume of the fluid in the model of dynamics of the solid-state matter. Coupling the dynamics of the solid-state matter and the liquid-state matter in such a manner establishes a heterogenous model of dynamics of the system.

According to an embodiment, the heterogeneous model of the dynamics of the system includes a model of dynamics of the solid-state matter mutually coupled with a model of dynamics of the volume of the fluid in the container. The model of dynamics of the volume of the fluid estimates the shape of the volume of the fluid caused by the motion of the container. The model of dynamics of the solid-state matter includes the center of mass of the volume of the fluid dependent on the shape of the volume of the fluid. Such a heterogenous model is used to consider the sloshing of the fluid in controlling of the system.

For example, at first, a feedback signal indicative of a state of the system is collected. Examples of the state of system includes an orientation of the system, a position of the system, a velocity of the system, or acceleration of the system. Further, a control command to an actuator of the system is determined by solving an optimal control problem changing the state of the system according to a control objective. The optimal control problem is subject to the heterogenous model of the dynamics of the system including the model of dynamics of the solid-state matter mutually coupled with the model of dynamics of the volume of fluid. Furthermore, the control command is submitted to the actuator of the system to change the state of the system.

According to an embodiment, the shape of the volume of the fluid in the container is determined by a profile of an interface between the estimated volume of fluid estimated and the remaining volume in the container. The remaining volume in the container relates to air or vapor or void that is not occupied by the fluid The profile of the interface is estimated using principles of Computational Fluid Dynamics (CFD). In other words, the shape of the volume of the fluid can be determined using CFD. For example, boundary conditions are determined based on the motion of the container. Further, based on the boundary conditions, CFD simulation of the volume of the fluid is executed. From the CFD simulation, the shape of the volume of the fluid and the center of mass of the volume of the fluid may be determined.

Accordingly, one embodiment discloses a controller for controlling a system with mixed-state matter including a solid-state matter with parts forming a container including a volume of fluid. The controller comprises a memory configured to store executable instructions; and a processor configured to execute the executable instructions to cause the controller to: collect a feedback signal indicative of a state of the system; determine a control command to an actuator of the system at a current control step by solving an optimal control problem changing the state of the system according to a control objective subject to a heterogenous model of dynamics of the system including a model of dynamics of the solid-state matter mutually coupled with a model of dynamics of the volume of fluid in the container, wherein the model of dynamics of the volume of fluid estimates a shape of the volume of fluid caused by the motion of the container in response to execution of the control command at the current control step, and wherein the model of dynamics of the solid-state matter includes a center of mass of the volume of fluid within the container dependent on the shape of the volume of fluid at the current control step; and submit the control command to the actuator of the system to change the state of the system.

Accordingly, another embodiment discloses a method for controlling a system with mixed-state matter including a solid-state matter with parts forming a container including a volume of fluid. The method comprises collecting a feedback signal indicative of a state of the system; determining a control command to an actuator of the system at a current control step by solving an optimal control problem changing the state of the system according to a control objective subject to a heterogenous model of dynamics of the system including a model of dynamics of the solid-state matter mutually coupled with a model of dynamics of the volume of fluid in the container, wherein the model of dynamics of the volume of fluid estimates a shape of the volume of fluid caused by the motion of the container in response to execution of the control command at the current control step, and wherein the model of dynamics of the solid-state matter includes a center of mass of the volume of fluid within the container dependent on the shape of the volume of fluid at the current control step; and submitting the control command to the actuator of the system to change the state of the system.

Accordingly, yet another embodiment discloses a non-transitory computer-readable storage medium embodied thereon a program executable by a processor for performing a method for controlling a system with mixed-state matter including a solid-state matter with parts forming a container including a volume of fluid. The method comprises collecting a feedback signal indicative of a state of the system; determining a control command to an actuator of the system at a current control step by solving an optimal control problem changing the state of the system according to a control objective subject to a heterogenous model of dynamics of the system including a model of dynamics of the solid-state matter mutually coupled with a model of dynamics of the volume of fluid in the container, wherein the model of dynamics of the volume of fluid estimates a shape of the volume of fluid caused by the motion of the container in response to execution of the control command at the current control step, and wherein the model of dynamics of the solid-state matter includes a center of mass of the volume of fluid within the container dependent on the shape of the volume of fluid at the current control step; and submitting the control command to the actuator of the system to change the state of the system.

### BRIEF DESCRIPTION OF THE DRAWINGS

FIG. 1A illustrates a block diagram for controlling a system with mixed-state matter, according to an embodiment of the present disclosure.

FIG. 1B illustrates the system with mixed-state matter, according to an embodiment of the present disclosure.

FIG. 1C illustrates a shape of a volume of fluid changing over time in a container due to fluid sloshing, according to an embodiment of the present disclosure.

FIG. 1D illustrates a change in a location of a center of mass of the volume of fluid due to change in the shape of the volume of fluid, according to an embodiment of the present disclosure.

FIG. 1E illustrates a heterogenous model of dynamics of the system, according to an embodiment of the present disclosure.

FIG. 1F illustrates a block diagram of a controller for controlling the system, according to some embodiments of the present disclosure.

FIG. 2 illustrates a block diagram of a method for determining the shape of the volume of the fluid using Computational Fluid Dynamics (CFD), according to an embodiment of the present disclosure.

FIG. 3 illustrates a schematic illustrating a representation of parametric physics models that model dynamics of the fluid, according to some embodiments of the present disclosure.

FIG. 4 illustrates an algorithm for Dynamic Mode Decomposition (DMD), according to some embodiments of the present disclosure.

FIG. 5 illustrates a schematic of a Kalman filter tracking the shape the volume of the fluid at a time instant, according to an embodiment of the present disclosure.

FIG. 6 illustrates a spacecraft employing the controller, according to some embodiments of the present disclosure.

FIG. 7 is a schematic illustrating a computing device for implementing the controller, according to some embodiments of the present disclosure.

The presently disclosed embodiments will be further explained with reference to the attached drawings. The drawings shown are not necessarily to scale, with emphasis instead generally being placed upon illustrating the principles of the presently disclosed embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

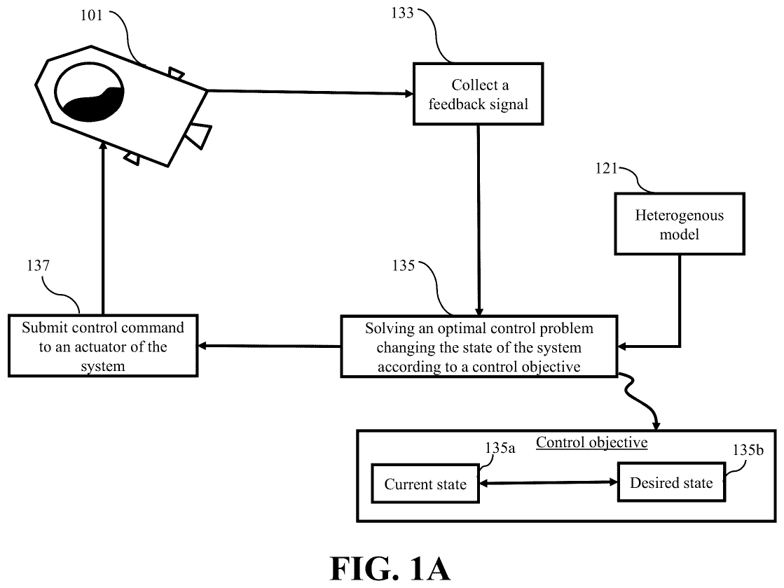

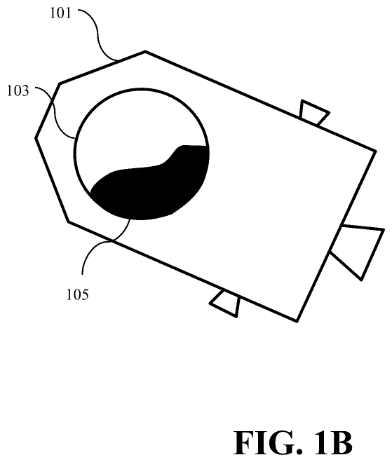

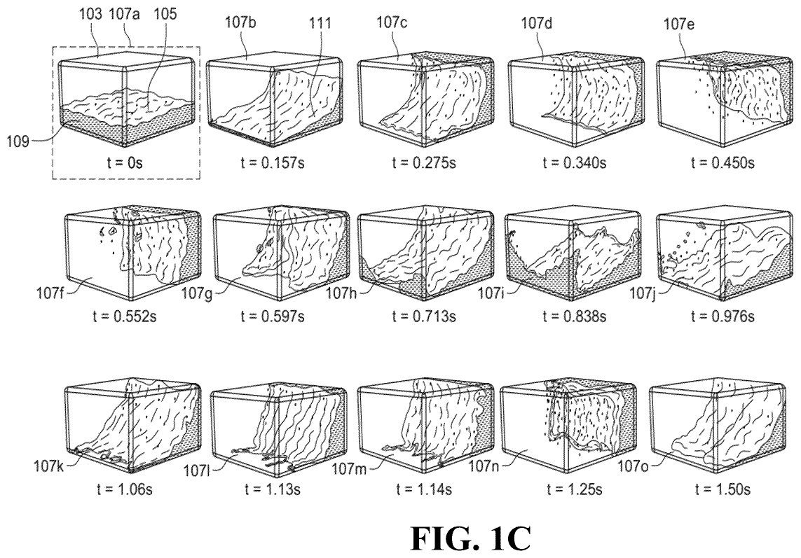

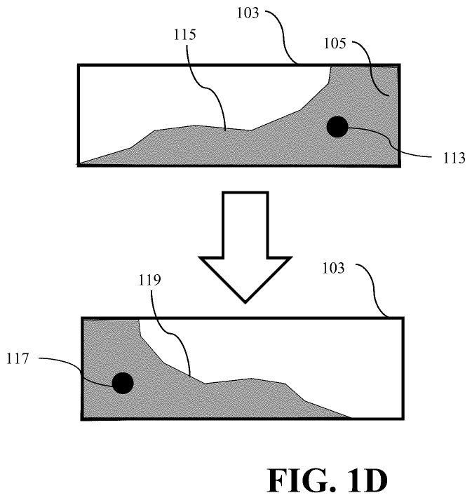

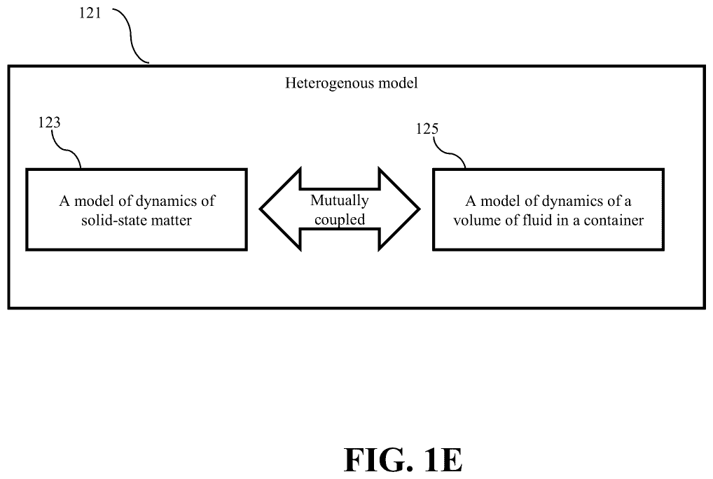

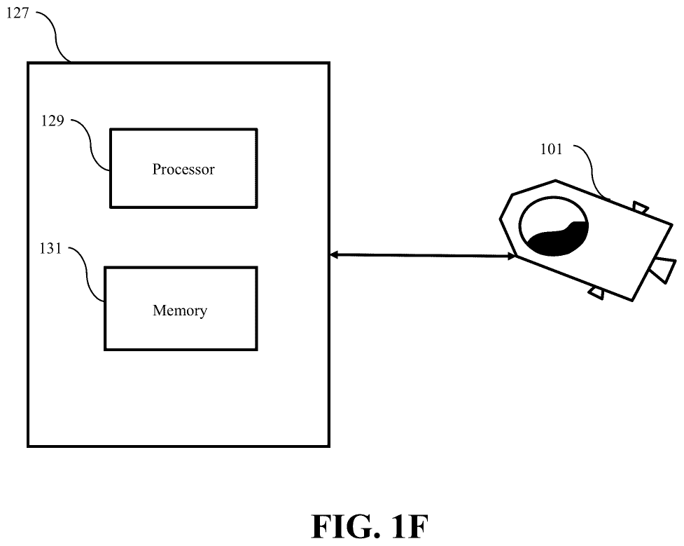

FIG. 1A illustrates a block diagram for controlling a system 101, according to an embodiment of the present disclosure. FIG. 1B illustrates the system 101, according to an embodiment of the present disclosure. The system 101 includes mixed-state matter including solid-state matter with parts forming a container 103. The container 103 includes a fluid 105 of certain volume. The container 103 may be of any shape and size as per need of the system 101. Examples of the system 101 with the mixed-state matter include a spacecraft having a container with fuel powering its motion, and a robot carrying a container with water or other types of fluid.

When the system 101 is under operation, the container 103 is subjected to external forces due to which sloshing of the fluid 105 occurs. For example, during flight of the spacecraft, the sloshing of the volume of the fluid 105 may occur due to motion of the container 103. Due to the sloshing of the fluid 105, a shape of the volume of the fluid 105 changes, as shown in FIG. 1C

FIG. 1C illustrates the shape of the volume of the fluid 105 changing over time in the container 103 due to the fluid sloshing, according to an embodiment of the present disclosure. 107a shows the shape of the volume of the fluid 105 at time instant t=0 s. Likewise, 107b shows the shape of the volume of the fluid 105 at time instant t=0.157 s. 107c shows the shape of the volume of the fluid 105 at time instant t=0.275 s. 107d shows the shape of the volume of the fluid 105 at time instant t=0.340 s. 107e shows the shape of the volume of the fluid 105 at time instant t=0.450 s. 107e shows the shape of the volume of the fluid 105 at time instant t=0.552 s. 107f shows the shape of the volume of the fluid 105 at time instant t=0.552 s. 107g shows the shape of the volume of the fluid 105 at time instant t=0.597 s. 107h shows the shape of the volume of the fluid 105 at time instant t=0.713 s. 107i shows the shape of the volume of the fluid 105 at time instant t=0.838 s. 107j shows the shape of the volume of the fluid 105 at time instant t=0.976 s. 107k shows the shape of the volume of the fluid 105 at time instant t=1.06 s. 107l shows the shape of the volume of the fluid 105 at time instant t=1.13 s. 107m shows the shape of the volume of the fluid 105 at time instant t=1.14 s. 107n shows the shape of the volume of the fluid 105 at time instant t=1.25 s. 107o shows the shape of the volume of the fluid 105 at time instant t=1.50 s.

It may be observed from FIG. 1C that the shape of the volume of the fluid 105 changes over time in the container 103 due to the fluid sloshing. For example, a shape 109 of the volume of the fluid 105 at the time instant t=0 s changes to a shape 111 of the volume of the fluid 105 at next time instant t=0.157 s.

Further, some embodiments are based on the recognition that change in the shape of the volume of the fluid 105 changes a location of a center of mass of the volume of fluid 105. FIG. 1D illustrates a change in the location of the center of mass of the volume of fluid 105 due to change in the shape of the volume of the fluid 105, according to an embodiment of the present disclosure. A location 113 of the center of mass of the volume of fluid 105 corresponding to a shape 115 of the volume of the fluid 105 changes to a location 117 when then the shape 115 of the volume of the fluid 105 changes to a shape 119. Additionally, the change in the shape of the volume of the fluid 105 changes velocity of the fluid 105

Some embodiments are based on the recognition that dynamics of the mixed-state matters are mutually coupled, i.e., the dynamics of the solid-state matter (e.g., container 103) and liquid-state matter (fluid 105) affect each other, and in theory, the mutual coupling between the dynamics of the solid-state matter and the liquid-state matter should be considered in designing a controller for controlling the system 101. However, such a mutual coupling is difficult to model.

Some embodiments are based on the realization that the mutual coupling between the dynamics of the solid-state matter and the liquid-state matter can be done by estimating the shape of the volume of the fluid 105 caused by the motion of the container 103. Some embodiments are based on the further realization that the shape of the volume of the fluid 105 changes the location of the center of mass of the volume of the fluid 105, and, hence, the mutual coupling can be done by including the center of mass of the volume of the fluid 105 in a model of dynamics of the solid-state matter. Additionally, in some embodiments, the mutual coupling is done by including velocity of the fluid 105 in the model of dynamics of the solid-state matter. In some alternate embodiments, the mutual coupling is done by including both the velocity of the fluid 105 and the center of mass of the volume of the fluid 105 in the model of dynamics of the solid-state matter. Coupling the dynamics of the solid-state matter and the liquid-state matter in such a manner establishes a heterogenous model of dynamics of the system 101.

FIG. 1E illustrates a heterogenous model 121 of the dynamics of the system 101, according to an embodiment of the present disclosure. The heterogeneous model 121 of the dynamics of the system 101 includes a model 123 of dynamics of the solid-state matter mutually coupled with a model 125 of dynamics of the volume of the fluid 105 in the container 103. The model 125 of dynamics of the volume of the fluid 105 estimates the shape of the volume of the fluid 105 caused by the motion of the container 103. The model 123 of dynamics of the solid-state matter includes the center of mass of the volume of the fluid 105 dependent on the shape of the volume of the fluid 105.

Further, some embodiments provide a controller that controls the system 101, using the heterogenous model 121 to consider the sloshing of the fluid in controlling of the system 101. Such a controller is described below in FIG. 1F.

FIG. 1F shows a block diagram of a controller 127 for controlling the system 101, according to some embodiments of the present disclosure. The controller 127 is communicatively coupled to the system 101. The controller 127 includes a processor 129 and a memory 131. The processor 129 may be a single core processor, a multi-core processor, a computing cluster, or any number of other configurations. The memory 131 may include random access memory (RAM), read only memory (ROM), flash memory, or any other suitable memory systems. Additionally, in some embodiments, the memory 131 may be implemented using a hard drive, an optical drive, a thumb drive, an array of drives, or any combinations thereof. The memory 131 is configured to store executable instructions, and the processor 129 is configured to execute the executable instructions to cause the controller 127 to control the system 101 using the heterogenous model 121, as described below.

Referring back to FIG. 1A, at block 133, the processor 129 is configured of the controller 127 to collect a feedback signal indicative of a state of the system 101. The state of the system 101 may correspond to an orientation of the system 101, a position of the system 101, a velocity of the system 101, or an acceleration of the system 101.

At block 135, the processor 129 is configured to solve, at a current control step, an optimal control problem changing the state of the system 101 according to a control objective, to determine a control command to an actuator of the system 101. The control objective may be reducing a difference between a current state 135a of the system 101 and a desired state 135b of the system 101. For instance, the control objective may be maneuvering the system 101 to a target position or orientation from a current target position or orientation. The optimal control problem is subject to the heterogenous model 121 of the dynamics of the system 101 including the model 123 of dynamics of the solid-state matter mutually coupled with the model 125 of dynamics of the volume of the fluid 105. The model 125 of dynamics of the volume of the fluid 105 estimates a shape of the volume of the fluid 105 caused by the motion of the container 103 in response to execution of the control command at the current control step. The model 123 of dynamics of the solid-state matter includes a center of mass of the volume of the fluid 105 within the container 103 dependent on the shape of the volume of the fluid 105 at the current control step.

In some other embodiments, the processor 129 may solve Model Predictive Control (MPC) problem or other feedback control problem subject to the heterogenous model 121 to determine the control command to the actuator of the system 101. Alternatively, data-driven control techniques, such as reinforcement learning, can also be used to determine the control command to the actuator of the system 101. Further, adaptive control problems, such as Extremum seeking, subject to the heterogenous model 121 may be solved to determine the control command to the actuator of the system 101.

At block 137, the processor 129 is configured to submit the control command to the actuator of the system 101 to change the state of the system 101. Further, for the next current control step, the processor 129 collects a new feedback signal and the same process is executed. In such a manner, the heterogenous model 121 is used to consider the mutual coupling between the dynamics of the solid-state matter and the liquid-state matter of the system 101 and determine the control command for controlling the system 101.

According to an embodiment, the shape of the volume of the fluid 105 in the container 103 is determined by a profile of an interface between the volume of fluid estimated for the current control step and the remaining volume in the container. The profile of the interface is estimated using principles of Computational Fluid Dynamics (CFD). In other words, the shape of the volume of the fluid 105 can be determined using CFD.

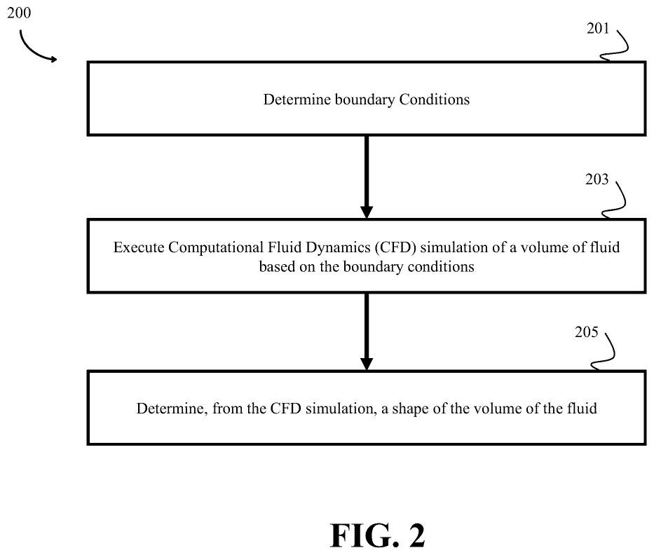

FIG. 2 shows a block diagram 200 for determining the shape of the volume of the fluid 105 using CFD, according to an embodiment of the present disclosure. At block 201, the processor 129 determines boundary conditions based on the motion of the container 103.

At block 203, the processor 129 executes CFD simulation of the volume of the fluid 105 based on the boundary conditions. In particular, the processor 129 simulates Partial Differential Equations (PDEs) that describe the fluid motion, based on the boundary conditions. For example, for a two phase flow related to sloshing problems, liquid (fluid 105) and air are considered as two immiscible fluids. Incompressible Navier-Stokes PDE describes dynamics along an explicit equation for an interface manifesting itself as fluid fraction quantity. Such dynamics can be solved using, for example, Volume of Fluid (VOF) method. The VOF method provides a simple and economical way to track free boundaries in two- or three-dimensional grids, and is more flexible and efficient in dealing with problems involving highly complex free surface configurations.

At block 205, the processor 129 determine, from the CFD simulation, the shape of the volume of the fluid 105 and the center of mass of the volume of the fluid 105. Additionally, in some embodiments, the processor 129 computes, from the CFD simulation, a velocity of the fluid 105.

Some embodiments are based on the recognition that CFD simulation with the PDEs is too computationally heavy for use in real-time control. Some embodiments are based on the realization that, such a problem can be mitigated by simulating CFD of the volume of fluid using a reduce-order model approximating a full CFD model. The full CFD model is a PDE model, and a degree of the reduce-order model is less than a degree of the PDE model. The use of reduced-order models (ROMs), i.e., reducing the PDE model to a system of finite-dimensional ordinary differential equations (ODEs), lessens the computational burden. In an embodiment, the ROMs are determined based on parametric physics models.

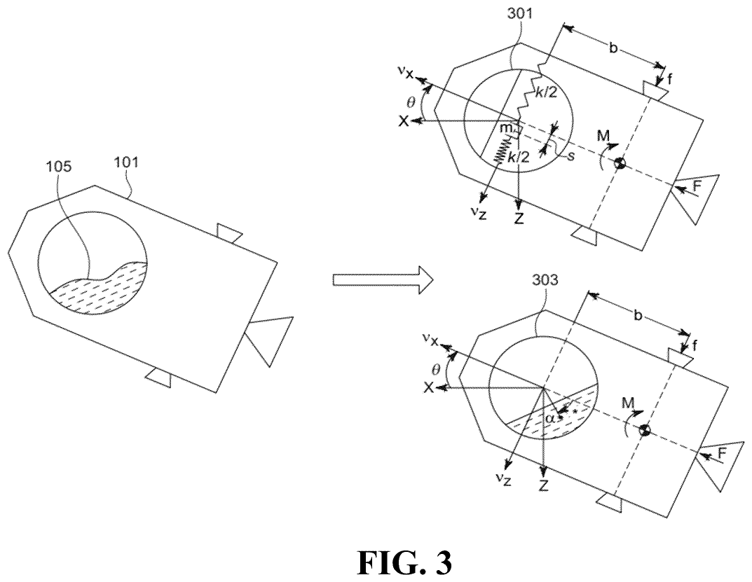

FIG. 3 shows a schematic illustrating a representation of the parametric physics models that model the dynamics of the fluid 105, according to some embodiments of the present disclosure. The dynamics of the fluid 105 may be modeled as a mass-damper-spring system 301 or a pendulum system 303 amongst other possible models. Parameters of the mass-damper-spring system 301 and the pendulum system 303, such as number and weight of masses, number, stiffness of springs, an inertia tensor of the fuel, and damper coefficients are calibrated based on the CFD simulations. Some embodiments use least square technique for estimation of the parameters of the mass-damper-spring system 301 and the pendulum system 303 from CFD data.

In some alternate embodiments, the ROMs are obtained based on Proper Orthogonal Decomposition (POD). The POD is data based, in that a suitable orthonormal basis is determined from observed or experimental data, so as to capture and order relevant information from spatial dynamics of the system 101. In some other embodiments, the ROM is obtained by a Galerkin projection of the system dynamics on the first few, and most relevant basis functions. In mathematics, in the area of numerical analysis, Galerkin methods, convert a continuous operator problem, such as a differential equation, to a discrete problem by applying linear constraints determined by finite sets of basis functions.

The POD originates from a field of turbulence as an attempt to decompose a random vector field representing turbulent fluid velocity into a set of deterministic functions that each capture some portion of a total fluctuating kinetic energy in fluid flow. The POD determines elusive coherent structures that populate turbulent flows. Therefore, the POD provides a technique for analyzing multidimensional data. The POD essentially provides an orthonormal basis for representing given data in a certain least squares optimal sense. The POD may be applied to infinite dimensional data such as fluid flow patterns as well. Truncation of optimal basis provides a way to find optimal lower dimensional approximations of the given data. In the present disclosure, the fluid velocity and the volume of fluid are determined using the CFD data, and they are of very large dimension at each time instant. POD analysis using singular value decomposition, finds an optimal leading basis that can represent the fluid velocity and the volume of fluid. In the next step, combine POD with Galerkin projection to develop a method for generating lower dimensional models of liquid slosh dynamics that has a very large or even infinite dimensional phase space. The Galerkin projection is a mathematical framework, when a solution (e., the fluid velocity and the volume of fluid) is represented as a linear combination of POD modes and then inserted into governing PDE (which is Navier-Stokes equation). Orthogonality of the POD modes along with truncation is used to construct a low-order ODE. In short, POD-Galerkin method takes snapshots of fluid properties (velocity, volume of fluid) and transfer them into a low-order ODE that can be used for prediction and control.

Alternatively, in some embodiments, the ROM is obtained by computing a set of modes based on Dynamic Mode Decomposition (DMD), wherein each mode is associated with temporal features and correlated spatial activity. Given a time series of data, DMD computes a set of modes each of which is associated with a fixed oscillation frequency and decay/growth rate. Due to intrinsic temporal behaviors associated with each mode, DMD differs from dimensionality reduction methods such as principal component analysis, which computes orthogonal modes that lack predetermined temporal behaviors.

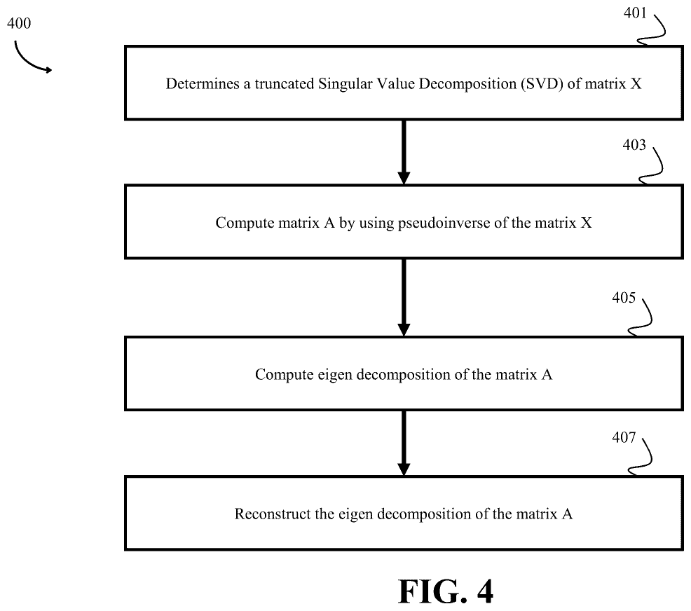

FIG. 4 illustrates an algorithm 400 for DMD, according to some embodiments of the present disclosure. The DMD provides a spatiotemporal decomposition of data into a set of dynamic modes that are derived from snapshots or measurements of the system 101 in time. The data includes solution of the CFD in forms of the velocity and the volume of the fluid 105. Data collection process involves two parameters: n=number of spatial points saved per time snapshot, m=number of snapshots taken. To achieve DMD, a suitable linearly independent set of modes {u₁, . . . , uᵣ}, where uᵢ∈Rⁿ, defining an r-dimensional subspace of Rⁿ in which most of the dynamics is assumed to take place, is chosen. Stacking the set of modes as columns of a matrix U∈R^{n×r}, a parameter zₖ can be expressed as zₖ≅Uxₖ, where a reduced-order state xₖ∈R^{r} represents coordinates of zₖ in the subspace, where the parameter zₖ represents a physical state space, e.g. fuel velocity, pressure or volume fraction. Subsequently, a ROM for dynamics of xₖ, which is vastly cheaper to evolve than original full-order dynamics when r<<n, may be determined.

Different approaches can be used to determine an appropriate set of modes U and corresponding ROM for the dynamics of xₖ. For instance, the DMD can be used to determine the set of modes U. Starting with a collection of snapshots Z={z₀, . . . , zₘ}, the DMD seeks a best-fit linear model of the dynamics in form of a matrix A∈R^{n×n} such that zₖ+1≅Azₖ, and computes the set of modes U as r leading principal component analysis (PCA) modes of Z. Transformation zₖ≅Uxₖ and orthogonality of U then yield a linear discrete-time ROM of form

$$\begin{matrix}{x}_{k + 1} = {A}_{r} {x}_{k} + {w}_{k} , \\ {y}_{k} = {C}_{r} {x}_{k} + {v}_{k} ,\end{matrix}$$

where Ar=U^{T}AU∈R^{r×r} and Cᵣ=CU∈R^{p×r} are reduced-order state-transition and observation models, respectively. Therefore, a relationship between physical fluid flow Z={z₀, . . . , zₘ} and reduced-order state xₖ∈R^{r} can be determined, where xₖ is described by a linear model even though zₖ is described by nonlinear model.

In practice, when state dimension n is large, the matrix A may be intractable to analyze directly. Instead, the DMD circumvents calculation of pseudo-inverse of A by considering a rank-reduced representation in terms of a POD-projected matrix Ã. To that end, the algorithm 400 for the DMD proceeds as follows. At block 401, the processor 129 determines a truncated Singular Value Decomposition (SVD) of snapshot matrix X. For instance, at first, the processor 129 obtains the SVD of snapshot matrix X:

X≈UΣV*,

where * denotes a conjugate transpose, U∈ [symbol] ^{n×r}, Σ∈ [symbol] ^{r×r}, and V∈ [symbol] ^{n×r}. Here r is a rank of a reduced SVD approximation to X. Left singular vectors U are POD modes. Columns of U are orthonormal, therefore, U*U=I; similarly, V*V=I. Further, SVD reduction is exploited to perform a low-rank truncation of the data. Specifically, if low-dimensional structure is present in the data, singular values of Σ may decrease sharply to zero with perhaps only a limited number of dominant modes.

At block 403, the processor 129 computes the matrix A by using pseudoinverse of X determined via the SVD:

$$A = {X}^{‵} V {Σ}^{- 1} {U}^{*} .$$

where X′ is a shifted version of X in time (one time step). In practice, it is more efficient computationally to compute matrix Ã, a r×r projection of the matrix A onto the POD modes:

$$\tilde{A} = U * AU = U * {X}^{‵} V {Σ}^{- 1} .$$

The matrix Ã defines a low-dimensional linear model of the system 101 on POD coordinates as \tilde{x}ₖ₊₁=Ã\tilde{x}ₖ, Further, a high-dimensional state may be computed as xₖ=U\tilde{x}ₖ.

At block 405, the processor 129 computes eigen decomposition of the matrix A:

AW=WΛ,

where columns of W are eigenvectors and Λ is a diagonal matrix including corresponding eigenvalues λₖ.

At block 407, the processor 129 reconstructs the eigen decomposition of the matrix A from W and Λ. In particular, eigenvalues of A are given by Λ and eigenvectors of A (DMD modes) are given by columns of Φ:

$$Φ = XV {Σ}^{- 1} W .$$

With low-rank approximations of both the eigenvalues and the eigenvectors, a projected future solution can be constructed for all time in the future. For example, by first rewriting for convenience ωₖ=ln(λₖ)/Δt, an approximate solution at all future times is given by

$$x ( t ) \approx \sum \qquad {φ}_{k} exp ( {ω}_{k} t ) bk = Φ exp ( Ω t ) b ,$$

where bₖ is an initial amplitude of each mode, Φ is a matrix whose columns are DMD eigenvectors φₖ, and Ω=diag(ω) is a diagonal matrix whose entries are eigenvalues ωₖ.

Some embodiments are based on the recognition that while the ROMs are computationally inexpensive, the ROMs can introduce stability loss and prediction degradation. The stability loss and prediction degradation are due to truncation of higher modes and parametric uncertainties. More specifically, basis functions (spatial modes) obtained from data snapshots at one given set of parameters, may show deterioration in the accuracy of the ROMs prediction or even become unstable when applied to represent solutions for a different range of parameters. To that end, simulating the volume of the fluid 105 using the ROMs yields inaccurate estimate of the shape of the volume of the fluid 105.

Some embodiments are based on the realization that shape of the volume of the fluid 105 may be accurately determined by using a probabilistic filter, e.g., Kalman filter. One or more sensors, such as a camera and a pressure sensor, may be associated with the container 103. The processor 129 collects, from the one or more sensors, measurements of the volume of the fluid 105 in the container 103 and measurements of occupancy of the fluid 105 at a plurality of points in the container 103. The measurements of the camera are incorporated into the Kalman filter tracking the shape of the volume of the fluid 105.

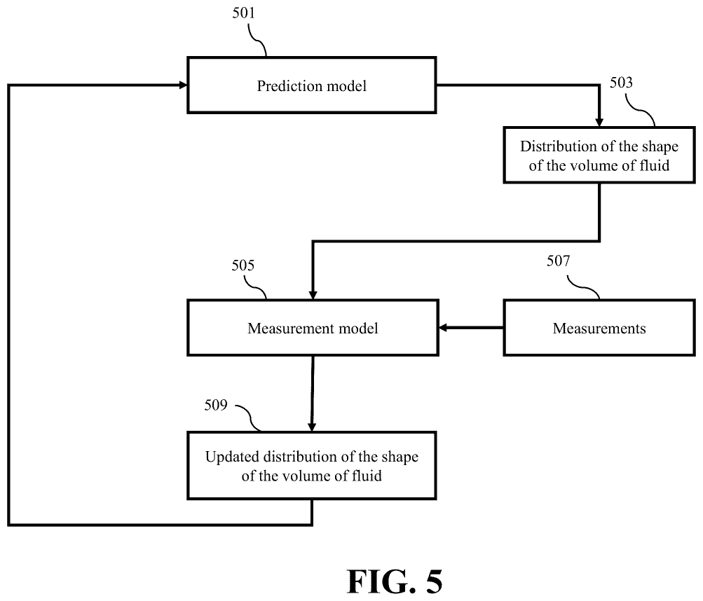

FIG. 5 shows a schematic of a Kalman filter tracking the shape the volume of the fluid 105 at a time instant, according to an embodiment of the present disclosure. The Kalman filter is executed by the processor 129. The Kalman filter tracks the shape of the volume of fluid 105 using a prediction model 501 subject to process noise and a measurement model 505 subject to measurement noise.

The prediction model 501 simulates CFD of the volume of fluid given the motion of the container 103 as the boundary conditions, to predict a distribution 503 of the shape of the volume of the fluid 105. The measurement model 505 updates the predicted distribution 503 of the shape of the volume of the fluid 105, based on measurements 507 of occupancy of the fluid 105 collected from the one or more sensors, to produce an updated distribution 509 of the shape of the volume of the fluid 105.

Further, some embodiments use Kalman filter along with the DMD for estimation of high-dimensional state zₖ because the ROM may not be accurate. Furthermore, the measurements of the system 101, which, upon assimilation into DMD, can be used to improve the accuracy and stability of the ROM. Since DMD provides a linear model, and with access to the measurements of the system 101 to improve the accuracy and the stability of the ROM, Kalman filter may be used for data assimilation and optimal estimation. For example, in an embodiment, given a sequence of measurements {y₀, . . . , yₖ}, a ROM defined by the matrix X and the system defined as

$$\begin{matrix}{x}_{k + 1} = {A}_{r} {x}_{k} + {w}_{k} , \\ {y}_{k} = {C}_{r} {x}_{k} + {v}_{k} ,\end{matrix}$$

whose matrices are given by, e.g., DMD, it is desired to estimate the high-dimensional state zₖ at current time k. To this end, a reduced-order estimator (ROE) is given as

$${\hat{x}}_{k} = {A}_{r} {\hat{x}}_{k - 1} + {a}_{k} ,$$

The Kalman filter is a special case of such an estimator, for which an optimal linear estimator is given by

$${a}_{k} = {K}_{k} ( {y}_{k} - {C}_{r} {A}_{r} {\hat{x}}_{k - 1} ) ,$$

with Kₖ∈R^{r×p} an optimal Kalman gain. Although the Kalman filter is optimal when state-transition and observation models are known exactly, its performance suffers in presence of unmodeled dynamics. Such model errors are due to the ROM being an inherent approximation of high-dimensional dynamics. However, since the system 101 is fully observed by capturing image of the volume of the fluid 105 at each instant, the model errors due to the ROM can be modeled as uncertainties and therefore the dynamics the volume of the fluid 105 can be accurately estimated.

In an embodiment, the system 101 is a spacecraft that includes a container including fuel for the spacecraft 601. The spacecraft may employ the controller 127 for controlling of the spacecraft.

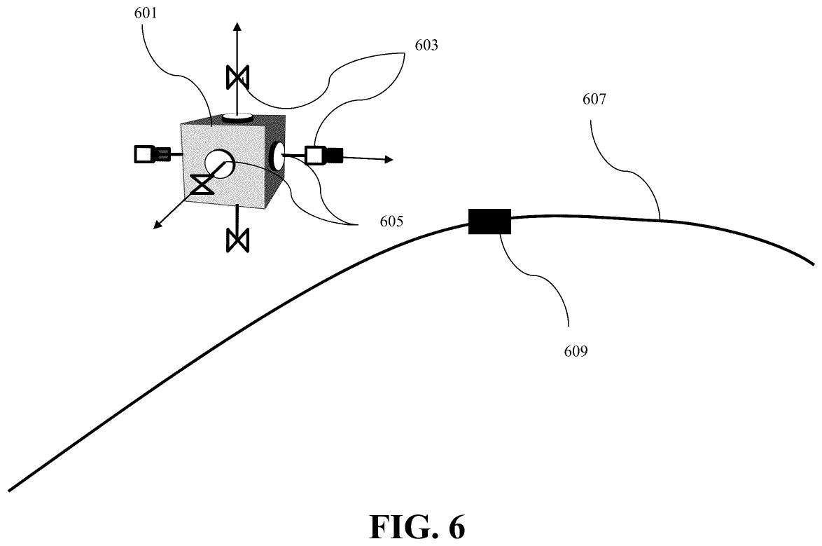

FIG. 6 shows a spacecraft 601 employing the controller 127, according to some embodiments of the present disclosure. The spacecraft 601 is communicatively coupled to the controller 127 (not shown in figure). The spacecraft 601 is equipped with actuators such as thrusters 603 and momentum exchange devices 605. Examples of the momentum exchange devices 605 include reaction wheels (RWs) and control moment gyroscopes.

The spacecraft 601 is a vehicle, vessel, or machine designed to fly in outer space whose operation changes quantities such as a position of the spacecraft, its velocities, and its attitude or orientation, in response to commands that are sent to the actuators. The spacecraft 601 includes a container including fuel for the spacecraft 601. When commanded, the actuators impart forces on the spacecraft 601 that increase or decrease the velocity of the spacecraft 601 and thus cause the spacecraft 601 to translate its position, and, when commanded, the actuators also impart torques on the spacecraft 601, which cause the spacecraft 601 to rotate and thereby change its attitude or orientation. The motion of the spacecraft 601 causes sloshing of the fuel.

The spacecraft 601 flies along an open or closed orbital path 607. A desired or target state along the orbital path 607 is specified by a user for the spacecraft 601. The desired state may include a desired position 609 and/or a desired orientation of the spacecraft 601. For the sake of explanation, the desired position 609 is considered to be the desired state. The controller 127 is configured to determine control commands to the actuators of the spacecraft 601 by solving an optimal control problem of reaching the desired position 607, wherein the optimal control problem is subject to the heterogenous model 121 which considers dynamics of the fuel of the spacecraft 601. The determined control commands cause the actuators to move the spacecraft 601 to the desired position 609. Since the spacecraft 601 is controlled by the control commands that are determined by considering the heterogenous model 121, which takes into account the dynamics of the fuel of the spacecraft 601, the spacecraft 601 is controlled accurately.

Alternatively, in some embodiments, the system 101 is a mobile robot carrying a liquid in a container. An acceleration of the mobile robot induces changing boundary conditions on the liquid in the container, which may in turn induce liquid slosh. The controller 127 may be configured for rapid and accurate control of the mobile robot by considering dynamics of the liquid in the container. For instance, the controller 127 may determine control commands to actuators of the mobile robot by solving an optimal control problem subject to a heterogenous model of dynamics of the mobile robot.

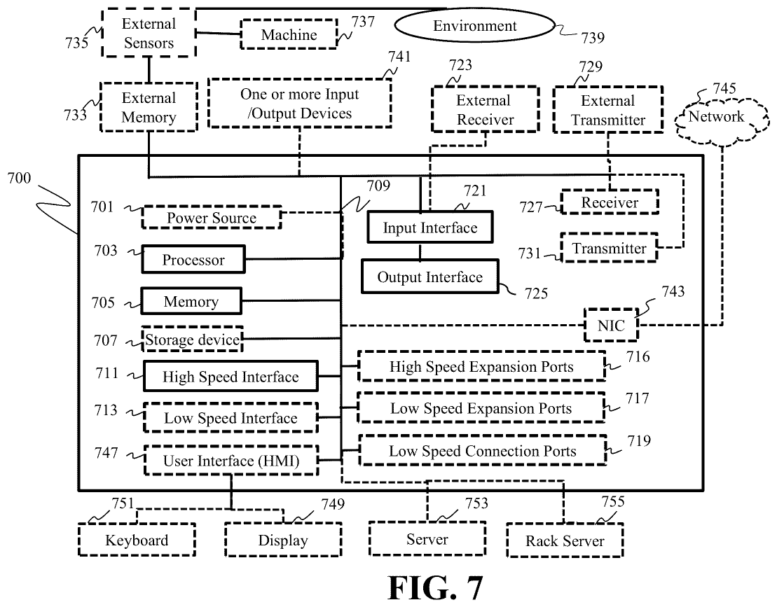

FIG. 7 is a schematic illustrating a computing device 700 for implementing the controller 127 of the present disclosure. The computing device 700 includes a power source 701, a processor 703, a memory 705, a storage device 707, all connected to a bus 709. Further, a high-speed interface 711, a low-speed interface 713, high-speed expansion ports 716 and low speed connection ports 717, can be connected to the bus 709. In addition, a low-speed expansion port 719 is in connection with the bus 709.

Further, an input interface 721 can be connected via the bus 709 to an external receiver 723 and an output interface 725. A receiver 727 can be connected to an external transmitter 729 and a transmitter 731 via the bus 709. Also connected to the bus 709 can be an external memory 733, external sensors 735, machine(s) 737, and an environment 739. Further, one or more external input/output devices 741 can be connected to the bus 709. A network interface controller (NIC) 743 can be adapted to connect through the bus 709 to a network 745, wherein data or other data, among other things, can be rendered on a third-party display device, third party imaging device, and/or third-party printing device outside of the computer device 700.

The memory 705 can store instructions that are executable by the computer device 700 and any data that can be utilized by the methods and systems of the present disclosure. The memory 705 can include random access memory (RAM), read only memory (ROM), flash memory, or any other suitable memory systems. The memory 705 can be a volatile memory unit or units, and/or a non-volatile memory unit or units. The memory 705 may also be another form of computer-readable medium, such as a magnetic or optical disk.

The storage device 707 can be adapted to store supplementary data and/or software modules used by the computer device 700. The storage device 707 can include a hard drive, an optical drive, a thumb-drive, an array of drives, or any combinations thereof. Further, the storage device 707 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 703), perform one or more methods, such as those described above.

The computing device 700 can be linked through the bus 709, optionally, to a display interface or user Interface (HMI) 747 adapted to connect the computing device 700 to a display device 749 and a keyboard 751, wherein the display device 749 can include a computer monitor, camera, television, projector, or mobile device, among others. In some implementations, the computer device 700 may include a printer interface to connect to a printing device, wherein the printing device can include a liquid inkjet printer, solid ink printer, large-scale commercial printer, thermal printer, UV printer, or dye-sublimation printer, among others.

The high-speed interface 711 manages bandwidth-intensive operations for the computing device 700, while the low-speed interface 713 manages lower bandwidth-intensive operations. Such allocation of functions is an example only. In some implementations, the high-speed interface 711 can be coupled to the memory 705, the user interface (HMI) 747, and to the keyboard 751 and the display 749 (e.g., through a graphics processor or accelerator), and to the high-speed expansion ports 716, which may accept various expansion cards via the bus 709. In an implementation, the low-speed interface 713 is coupled to the storage device 707 and the low-speed expansion ports 717, via the bus 709. The low-speed expansion ports 717, which may include various communication ports (e.g., USB, Bluetooth, Ethernet, wireless Ethernet) may be coupled to the one or more input/output devices 741. The computing device 700 may be connected to a server 753 and a rack server 755. The computing device 700 may be implemented in several different forms. For example, the computing device 700 may be implemented as part of the rack server 755.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the operation of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

Claimed is:

1. A controller for controlling a system with mixed-state matter including a solid-state matter with parts forming a container including a volume of fluid, the controller comprising: a memory configured to store executable instructions; and a processor configured to execute the executable instructions to cause the controller to:
collect a feedback signal indicative of a state of the system;
determine a control command to an actuator of the system at a current control step by solving an optimal control problem related to changing the state of the system according to a control objective subject to a heterogenous model of dynamics of the system including a model of dynamics of the solid-state matter mutually coupled with a model of dynamics of the volume of fluid in the container, wherein the model of dynamics of the volume of fluid estimates a shape of the volume of fluid caused by the motion of the container in response to execution of the control command at the current control step, and wherein the model of dynamics of the solid-state matter includes a center of mass of the volume of fluid within the container dependent on the shape of the volume of fluid at the current control step; and
submit the control command to the actuator of the system to change the state of the system.

2. The controller of claim 1, wherein the shape of the volume of fluid is determined by a profile of an interface between the volume of fluid estimated for the current control step and the remaining volume in the container.

3. The controller of claim 2, wherein the profile of the interface is estimated using principles of Computational Fluid Dynamics (CFD).

4. The controller of claim 1, wherein the model of dynamics of the fluid simulates Computational Fluid Dynamics (CFD) of the volume of fluid in the container.

5. The controller of claim 4, wherein the model of dynamics of the fluid simulates CFD of the volume of fluid using a reduced-order model approximating a full CFD model.

6. The controller of claim 5, wherein the full CFD model is a PDE model, and the degree of the reduced-order model is less than the degree of the PDE model.

7. The controller of claim 5, wherein the reduced-order model is based on one or more parametric physics models that model dynamics of the fluid.

8. The controller of claim 5, wherein the reduced-order model is obtained by computing a set of modes based on Dynamic Mode Decomposition (DMD), wherein each mode is associated with temporal features and a correlated spatial activity.

9. The controller of claim 1, wherein the processor is further configured to:
collect measurements of the volume of fluid in the container and measurements of occupancy of fluid at a plurality of points in the container; and
execute a probabilistic filter tracking the shape of the volume of fluid using a prediction model subject to process noise and a measurement model subject to measurement noise, wherein the prediction model simulates Computational Fluid Dynamics (CFD) of the volume of fluid with motion of the container as boundary conditions to predict a distribution of the shape of the volume of fluid, and wherein the measurement model updates the predicted distribution based on the measurements of occupancy of fluid.

10. The controller of claim 11, wherein the measurements of the volume of fluid in the container and the measurements of occupancy of fluid at the plurality of points in the container are collected from one or more sensors associated with the container.

11. The controller of claim 11, wherein the probabilistic filter is a Kalman filter.

12. The controller of claim 1, wherein the system is a spacecraft including a container, and wherein the container includes fuel for the spacecraft, and wherein the processor is further configured to:
determine control commands to one or more actuators of the spacecraft by solving an optimal control problem of reaching a desired state of the spacecraft, wherein the optimal control problem is subject to the heterogenous model; and
submit the control commands to the one or more actuators of the spacecraft to move the spacecraft to the desired state.

13. A method for controlling a system with mixed-state matter including a solid-state matter with parts forming a container including a volume of fluid, the method comprising:
collecting a feedback signal indicative of a state of the system;
determining a control command to an actuator of the system at a current control step by solving an optimal control problem changing the state of the system according to a control objective subject to a heterogenous model of dynamics of the system including a model of dynamics of the solid-state matter mutually coupled with a model of dynamics of the volume of fluid in the container, wherein the model of dynamics of the volume of fluid estimates a shape of the volume of fluid caused by the motion of the container in response to execution of the control command at the current control step, and wherein the model of dynamics of the solid-state matter includes a center of mass of the volume of fluid within the container dependent on the shape of the volume of fluid at the current control step; and
submitting the control command to the actuator of the system to change the state of the system.

14. The method of claim 13, wherein the shape of the volume of fluid is determined by a profile of an interface between the volume of fluid estimated for the current control step and the remaining volume in the container.

15. The method of claim 14, wherein the profile of the interface is estimated using principles of Computational Fluid Dynamics (CFD).

16. The method of claim 13, wherein the model of dynamics of the fluid simulates Computational Fluid Dynamics (CFD) of the volume of fluid in the container.

17. The method of claim 16, wherein the model of dynamics of the fluid simulates CFD of the volume of fluid using a reduce-order model approximating a full CFD model.

18. The method of claim 17, wherein the full CFD model is a PDE model, and the degree of the reduce-order model is less than the degree of the PDE model.

19. A non-transitory computer-readable storage medium embodied thereon a program executable by a processor for performing a method for controlling a system with mixed-state matter including a solid-state matter with parts forming a container including a volume of fluid, the method comprising:
collecting a feedback signal indicative of a state of the system;
determining a control command to an actuator of the system at a current control step by solving an optimal control problem changing the state of the system according to a control objective subject to a heterogenous model of dynamics of the system including a model of dynamics of the solid-state matter mutually coupled with a model of dynamics of the volume of fluid in the container, wherein the model of dynamics of the volume of fluid estimates a shape of the volume of fluid caused by the motion of the container in response to execution of the control command at the current control step, and wherein the model of dynamics of the solid-state matter includes a center of mass of the volume of fluid within the container dependent on the shape of the volume of fluid at the current control step; and
submitting the control command to the actuator of the system to change the state of the system.

20. The non-transitory computer-readable storage medium of claim 18, wherein the shape of the volume of fluid is determined by a profile of an interface between the volume of fluid estimated for the current control step and the remaining volume in the container.
